(19) United States
(12) Patent Application Publication
(10) Pub. No.: US 2023/0141015 A1
(43) Pub. Date: May 11, 2023

(54) POLYMER COMPOSITION

(71) Applicant: ENEOS CORPORATION, Tokyo (JP)

(72) Inventor: Keisuke CHINO, Tokyo (JP)

(73) Assignee: ENEOS CORPORATION, Tokyo (JP)

(21) Appl. No.: 17/919,714

(22) PCT Filed: Apr. 20, 2021
(86) PCT No.: PCT/JP2021/016029

§ 371 Date: Oct. 18, 2022

(30) Foreign Application Priority Data
Apr. 28, 2020 (JP) 2020-079271

(51) Int. Cl. C08L 91/06; C08L 23/20; C08K 3/34

(52) U.S. Cl. CPC C08L 91/06; C08L 23/20; C08K 3/346; C08L 2205/035; C08L 2207/322; C08L 2205/025; C08L 2312/00

(57) ABSTRACT

A polymer composition including: at least one polymer ingredient selected from the group consisting of a polymer (A) having a side chain (a) containing a hydrogen-bonding cross-linking moiety with a carbonyl-containing group and/or a nitrogen-containing heterocycle and having a glass transition point of 25° C. or lower, and a polymer (B) containing a hydrogen-bonding cross-linking moiety and a covalent-bonding cross-linking moiety in a side chain and having a glass transition point of 25° C. or lower, wherein both the polymer (A) and the polymer (B) are a reaction product of a cross-linking agent with a maleic anhydride graft-modified thermoplastic polymer having a melting point of 64° C. or lower and a maleation rate of 0.1 to 3.0% by mass, and a type A durometer hardness measured under a temperature condition of 20±5° C. according to JIS K6253-3: 2012 is 0 to 49.

### TECHNICAL FIELD

The present invention relates to a polymer composition.

### BACKGROUND ART

Conventionally, various polymer compositions have been studied in order to exhibit characteristics according to the application. For example, International Publication No. WO2020/027109 (PTL 1) discloses a resin composition comprising: at least one resin ingredient selected from the group consisting of a resin (A) having a side chain (a) containing a hydrogen-bonding cross-linking moiety with a carbonyl-containing group and/or a nitrogen-containing heterocycle and having a glass transition point of 25° C. or lower, and a resin (B) containing a hydrogen-bonding cross-linking moiety and a covalent-bonding cross-linking moiety in a side chain and having a glass transition point of 25° C. or lower, wherein both the resin (A) and the resin (B) are a reaction product of a cross-linking agent with a maleic anhydride-modified thermoplastic resin having a melting point of 68° C. to 134° C. and a maleation rate of 0.5 to 2.5% by mass. Such a resin composition described in PTL 1 makes it possible to achieve both of the two characteristics, resistance to compression set and fluidity, as sufficiently good ones. However, even in such a resin composition described in PTL 1, there is room for improvement so that it is non-sticky as well as sufficiently low in hardness and sufficiently excellent in resistance to compression set (sufficiently low in both the hardness value and the compression set value).

### CITATION LIST

### Patent Literature

[PTL 1] International Publication No. WO2020/027109

### SUMMARY OF INVENTION

### Technical Problem

The present invention has been made in view of the above-mentioned problems of the prior art, and an object thereof is to provide a polymer composition capable of being non-sticky and sufficiently lowering both the hardness value and the compression set value.

### Solution to Problem

The present inventors have conducted extensive studies to achieve the above-mentioned object, and have found as a result that when a polymer composition contains at least one polymer ingredient selected from the group consisting of a polymer (A) having a side chain (a) containing a hydrogen-bonding cross-linking moiety with a carbonyl-containing group and/or a nitrogen-containing heterocycle and having a glass transition point of 25° C. or lower, and a polymer (B) containing a hydrogen-bonding cross-linking moiety and a covalent-bonding cross-linking moiety in a side chain and having a glass transition point of 25° C. or lower, wherein both the polymer (A) and the polymer (B) are a reaction product of a cross-linking agent with a maleic anhydride graft-modified thermoplastic polymer having a melting point of 64° C. or lower and a maleation rate of 0.1 to 3.0% by mass, and a type A durometer hardness measured under a temperature condition of 20±5° C. according to JIS K6253-3: 2012 is 0 to 49, the obtained polymer composition can be made so that it is non-sticky as well as sufficiently low in both the hardness value and the compression set value. Thus, the present invention has been completed.

Specifically, the polymer composition of the present invention comprises:

at least one polymer ingredient selected from the group consisting of a polymer (A) having a side chain (a) containing a hydrogen-bonding cross-linking moiety with a carbonyl-containing group and/or a nitrogen-containing heterocycle and having a glass transition point of 25° C. or lower, and a polymer (B) containing a hydrogen-bonding cross-linking moiety and a covalent-bonding cross-linking moiety in a side chain and having a glass transition point of 25° C. or lower, wherein

both the polymer (A) and the polymer (B) are a reaction product of a cross-linking agent with a maleic anhydride graft-modified thermoplastic polymer having a melting point of 64° C. or lower and a maleation rate of 0.1 to 3.0% by mass, and

a type A durometer hardness measured under a temperature condition of 20±5° C. according to JIS K6253-3: 2012 is 0 to 49.

In the polymer composition of the present invention, it is preferable that the cross-linking agent is a compound having at least one of a hydroxyl group, an amino group, an imino group, and a thiol group.

Further, in the polymer composition of the present invention, it is preferable that the maleic anhydride graft-modified thermoplastic polymer is a polyolefin-based polymer graft-modified with maleic anhydride. Further, such a polyolefin-based polymer graft-modified with maleic anhydrides preferably a maleic anhydride graft-modified product of at least one polyolefin-based polymer selected from the group consisting of polypropylene, polyethylene, ethylene-butene copolymers, ethylene-propylene copolymers, ethylene-octene copolymers, and ethylene-propylene-diene copolymers.

Further, it is preferable that the polymer composition of the present invention further comprises clay. Further, it is preferable that the polymer composition of the present invention further comprises a styrene block copolymer having no chemically bondable cross-linking moiety. Further, it is preferable that the polymer composition of the present invention further comprises at least one plasticizer selected from the group consisting of process oils, polybutenes having no chemically bondable cross-linking moiety, and polyisobutylenes having no chemically bondable cross-linking moiety.

### Advantageous Effects of Invention

The present invention makes it possible to provide a polymer composition capable of being non-sticky and sufficiently lowering both the hardness value and the compression set value.

### DESCRIPTION OF EMBODIMENTS

Hereinafter, the present invention is described in detail according to its preferable embodiments.

A polymer composition of the present invention comprises at least one polymer ingredient selected from the group consisting of the polymer (A) and the polymer (B), wherein both the polymer (A) and the polymer (B) are a reaction product of a cross-linking agent with a maleic anhydride graft-modified thermoplastic polymer having a melting point of 64° C. or lower and a maleation rate of 0.1 to 3.0% by mass, and a type A durometer hardness measured under a temperature condition of 20±5° C. according to JIS K6253-3: 2012 is 0 to 49.

The polymer ingredient according to the present invention is at least one polymer selected from the group consisting of a polymer (A) having a side chain (a) containing a hydrogen-bonding cross-linking moiety with a carbonyl-containing group and/or a nitrogen-containing heterocycle and having a glass transition point of 25° C. or lower, and a polymer (B) containing a hydrogen-bonding cross-linking moiety and a covalent-bonding cross-linking moiety in a side chain and having a glass transition point of 25° C. or lower. In the polymers (A) and (B), the “side chain” refers to the side chain and the end of the polymer. In addition, the “side chain (a) containing a hydrogen-bonding cross-linking moiety with a carbonyl-containing group and/or a nitrogen-containing heterocycle” means that the carbonyl-containing group and/or the nitrogen-containing heterocycle (more preferably the carbonyl-containing group and the nitrogen-containing heterocycle) as a hydrogen-bonding cross-linking moiety has a chemically stable bond (covalent bond) to the atom (usually a carbon atom) forming the main chain of the polymer. In addition, “containing a hydrogen-bonding cross-linking moiety and a covalent-bonding cross-linking moiety in a side chain” is a concept including the case of containing both the hydrogen-bonding cross-linking moiety and the covalent-bonding cross-linking moiety in the side chain of the polymer by containing both side chains of a side chain having the hydrogen-bonding cross-linking moiety (hereinafter sometimes referred to as “side chain (a′)” for convenience) and a side chain having the covalent-bonding cross-linking moiety (hereinafter sometimes referred to as “side chain (b)” for convenience) as well as the case of containing both the hydrogen-bonding cross-linking moiety and the covalent-bonding cross-linking moiety in the side chain of the polymer by containing a side chain having both the hydrogen-bonding cross-linking moiety and the covalent-bonding cross-linking moiety (side chain containing both the hydrogen-bonding cross-linking moiety and the covalent-bonding cross-linking moiety in one side chain: hereinafter, such a side chain is sometimes referred to as “side chains (c)” for convenience).

From the viewpoint of the possibility of further lowering the hardness, the polymer ingredient is more preferably at least one selected from the group consisting of a polymer (B) containing a hydrogen-bonding cross-linking moiety and a covalent-bonding cross-linking moiety in a side chain and having a glass transition point of 25° C. or lower.

Since the polymers (A) and (B) are a reaction product of a cross-linking agent with the maleic anhydride graft-modified thermoplastic polymer, the main chain of the polymers (A) and (B) in the polymer ingredient (the type of polymer forming the main chain portion) is derived from the main chain of the maleic anhydride graft-modified thermoplastic polymer. Note that the thermoplastic polymer that forms the main chain portion of the polymers (A) and (B) (main chain of the maleic anhydride graft-modified thermoplastic polymer) is described later. In addition, the glass transition points of the polymers (A) and (B) are all 25° C. or lower as described above. In the present invention, the “glass transition point” is a glass transition point measured by differential scanning calorimetry (DSC). Note that, in the measurement, the rate of temperature rise is set to 10° C./min to carry out measurement. By setting the glass transition point of the polymer to 25° C. or lower, it is possible to impart flexibility in a normal operating temperature range (room temperature (25° C.) or higher).

In addition, as described above, the polymers (A) and (B) have as a side chain at least one of a side chain (a) containing a hydrogen-bonding cross-linking moiety with a carbonyl-containing group and/or a nitrogen-containing heterocycle; a side chain (a′) containing a hydrogen-bonding cross-linking moiety and a side chain (b) containing a covalent-bonding cross-linking moiety; and a side chain (c) containing a hydrogen-bonding cross-linking moiety and a covalent-bonding cross-linking moiety. Note that in the present invention, it can be said that the side chain (c) is a side chain that also functions as the side chain (b) while also functioning as the side chain (a′). Each side chain is described later.

<Side Chain (a′): Side Chain Containing Hydrogen-Bonding Cross-Linking Moiety>

The side chain (a′) containing a hydrogen-bonding cross-linking moiety may be a side chain that has a group capable of forming a hydrogen bond-based cross-link (such as a hydroxyl group or a hydrogen-bonding cross-linking moiety contained in the side chain (a) described later), and forms a hydrogen bond based on the group, and the structure thereof is not particularly limited. Here, the hydrogen-bonding cross-linking moiety is a moiety that cross-links the molecules of the polymer by hydrogen bonding. Note that cross-links by hydrogen bonding are formed only when there is a hydrogen acceptor (such as a group containing an atom containing a lone electron pair) and a hydrogen donor (such as a group having a hydrogen atom covalently bonded to an atom with high electronegativity). For this reason, in the absence of both hydrogen acceptor and hydrogen donor between the side chains of the polymer molecules, a cross-link by hydrogen bonding is not formed. Therefore, a hydrogen-bonding cross-linking moiety exists in the system only when both a hydrogen acceptor and a hydrogen donor are present between the side chains of the polymer molecules. Note that, in the present invention, the portion of the side chain that can function as a hydrogen acceptor and the portion that can function as a donor can be determined as a hydrogen-bonding cross-linking moiety based on the presence of both a portion capable of functioning as a hydrogen acceptor (such as a carbonyl group) and a portion capable of functioning as a hydrogen donor (such as a hydroxyl group) between the side chains of the polymer molecules.

As the hydrogen-bonding cross-linking moiety in the side chain (a′), the side chain (a) described later is more preferable from the viewpoint of forming a stronger hydrogen bond. In addition, from the same viewpoint, the hydrogen-bonding cross-linking moiety in the side chain (a′) is more preferably a hydrogen-bonding cross-linking moiety having a carbonyl-containing group and a nitrogen-containing heterocycle.

<Side Chain (a): Side Chain Containing Hydrogen-Bonding Cross-Linking Moiety with Carbonyl-Containing Group and/or Nitrogen-Containing Heterocycle>

The side chain (a) containing a hydrogen-bonding cross-linking moiety with a carbonyl-containing group and/or a nitrogen-containing heterocycle may be one that has a carbonyl-containing group and/or a nitrogen-containing heterocycle, and other configurations are not particularly limited. As the hydrogen-bonding cross-linking moiety, those having a carbonyl-containing group and a nitrogen-containing heterocycle are more preferable.

The carbonyl-containing group may be one that contains a carbonyl group, and is not particularly limited, and specific examples thereof include amides, esters, imides, carboxy groups, carbonyl groups, thioester groups, and acid anhydride groups. Note that, in the present invention, both the polymers (A) and (B) are a reaction product of a cross-linking agent with a maleic anhydride graft-modified thermoplastic polymer, and thus have a group derived from the “maleic anhydride group” of the maleic anhydride graft-modified thermoplastic polymer (such as an ester group, a carbonyl group, an amide group, an imide group, a carboxy group, an acid anhydride group, and the like, although it depends on the type and the like of the cross-linking agent reacted).

In addition, when the side chain (a) has a nitrogen-containing heterocycle, the nitrogen-containing heterocycle may be introduced into the side chain (a) directly or via an organic group, and its configuration or the like is not particularly limited. As the nitrogen-containing heterocycle, as long as the heterocycle contains a nitrogen atom, it is possible to use one whose heterocycle has a hetero atom other than a nitrogen atom, for example, a sulfur atom, an oxygen atom, a phosphorus atom, or the like. Note that the nitrogen-containing heterocycle may have a substituent. Here, using a nitrogen-containing heterocycle in the side chain (a) is preferable because the hydrogen bond forming a cross-link becomes stronger due to the heterocyclic structure, and the stretchability and impact resistance of the polymer composition are further improved. In addition, the nitrogen-containing heterocycle is preferably a 5-membered ring and/or a 6-membered ring from the viewpoint that the hydrogen bond becomes stronger, and the resistance to compression set and the mechanical strength are further improved. In addition, as the nitrogen-containing heterocycle, a nitrogen-containing heterocycle may be condensed with a benzene ring, or nitrogen-containing heterocycles may be condensed with each other. As the nitrogen-containing heterocycle, it is possible to appropriately use known ones (such as one described in paragraphs [0054] to [0067] of Japanese Patent No. 5918878, and one described in paragraphs [0035] to [0048] of Japanese Unexamined Patent Application Publication No. 2017-206604). Note that the nitrogen-containing heterocycle may have a substituent. Examples of the nitrogen-containing heterocycle include pyrrololine, pyrrolidone, oxindole (2-oxyindole), indoxyl (3-oxyindole), dioxyindole, isatin, indolyl, phthalimidine, β-isoindigo, monoporphyrin, diporphyrin, triporphyrin, azaporphyrin, phthalocyanine, hemoglobin, uroporphyrin, chlorophyll, phylloerythrin, imidazole, pyrazole, triazole, tetrazole, benzimidazole, benzopyrazole, benzotriazole, imidazoline, imidazolone, imidazolidone, hydantoin, pyrazoline, pyrazolone, pyrazolidone, indazole, pyridoindole, purine, cinnoline, pyrrole, pyrroline, indole, indoline, oxylindole, carbazole, phenothiazine, indolenine, isoindole, oxazole, thiazole, isoxazole, isothiazole, oxadiazole, thiadiazole, oxatriazole, thiatriazole, phenanthroline, oxazine, benzoxazine, phthalazine, pteridine, pyrazine, phenazine, tetrazine, benzoxazole, benzoisoxazole, anthranil, benzothiazole, benzofurazan, pyridine, quinoline, isoquinoline, acridine, phenanthridine, anthrazoline, naphthyridine, thiazine, pyridazine, pyrimidine, quinazoline, quinoxaline, triazine, histidine, triazolidine, melamine, adenine, guanine, thymine, cytosine, hydroxyethyl isocyanurate, and derivatives thereof.

From the viewpoint of good recyclability, compression set, hardness, and mechanical strength (especially tensile strength), the nitrogen-containing heterocycle is preferably at least one selected from a triazole ring, an isocyanurate ring, a thiadiazole ring, a pyridine ring, an imidazole ring, a triazine ring, and a hydantoin ring, each of which may have a sub stituent, and preferably at least one selected from a triazole ring, a thiadiazole ring, a pyridine ring, an imidazole ring, and a hydantoin ring, each of which may have a substituent.

Examples of the sub stituent that the nitrogen-containing heterocycle may have include a hydroxyl group, an amino group, an imino group, a carboxy group, an isocyanate group, an epoxy group, an alkoxysilyl group, and a thiol group (mercapto group). In addition, as the substituent, it is possible to use an alkyl group such as a methyl group, an ethyl group, an (iso)propyl group, or a hexyl group; an alkoxy group such as a methoxy group, an ethoxy group, or an (iso)propoxy group; a group made up of a halogen atom such as a fluorine atom, a chlorine atom, a bromine atom, or an iodine atom; a cyano group; an amino group; an imino group; an aromatic hydrocarbon group; an ester group; an ether group; an acyl group; a thioether group; or the like. In addition, the substitution positions of these substituents are not particularly limited, and the number of substituents is not limited either.

In addition, when both the carbonyl-containing group and the nitrogen-containing heterocycle are contained in the side chain (a), the carbonyl-containing group and the nitrogen-containing heterocycle may be introduced into the main chain as side chains independent of each other, but are preferably introduced into the main chain as one side chain in which the carbonyl-containing group and the nitrogen-containing heterocycle are bonded via different groups. The structure of the side chain (a) may be, for example, a structure as described in paragraphs [0068] to [0081] of JP 5918878 B.

In addition, the side chain (a) is formed by a reaction between a maleic anhydride graft-modified thermoplastic polymer and a cross-linking agent. As a cross-linking agent used when forming the side chain (a), it is possible to preferably use a compound capable of reacting with a maleic anhydride group to form a hydrogen-bonding cross-linking moiety (hereinafter simply referred to as a “compound that forms a hydrogen-bonding cross-linking moiety” in some cases). As the “compound that forms a hydrogen-bonding cross-linking moiety” which can be used as a cross-linking agent, it is possible to preferably use a compound capable of introducing a nitrogen-containing heterocycle. As described above, as the cross-linking agent, it is possible to preferably use the “compound that forms a hydrogen-bonding cross-linking moiety (more preferably a compound capable of introducing a nitrogen-containing heterocycle).” For example, the “compound that forms a hydrogen-bonding cross-linking moiety (more preferably a compound capable of introducing a nitrogen-containing heterocycle)” is preferably a compound having a substituent that reacts with a maleic anhydride group (such as a hydroxyl group, a thiol group, an amino group, or an imino group), and more preferably a compound having at least one of a hydroxyl group, an amino group, an imino group, and a thiol group. In addition, the compound having a substituent that reacts with a maleic anhydride group (more preferably a compound having at least one of a hydroxyl group, an amino group, an imino group, and a thiol group) particularly preferably has a nitrogen-containing heterocycle.

<Side Chain (b): Side Chain Containing Covalent-Bonding Cross-Linking Moiety>

In the present specification, the “side chain (b) containing a covalent-bonding cross-linking moiety” means a side chain containing a portion in which the molecules of the polymer forming the main chain are cross-linked by covalent bonds (covalent-bonding cross-linking moiety: for example, a portion that can be formed by reacting a maleic anhydride group with a cross-linking agent and that cross-links polymers by a chemically stable bond (covalent bond) such as at least one bond selected from the group consisting of amides, esters, and thioesters). Note that the side chain (b) is a side chain containing a covalent-bonding cross-linking moiety, but is used as the side chain (c) described later when it has a covalent bond moiety and also has a group capable of hydrogen bonding to form a cross-link by hydrogen bonding between side chains (note that, in the absence of both a hydrogen donor and a hydrogen acceptor capable of forming a hydrogen bond between the side chains of the polymer molecules, for example in the presence of only a side chain containing ester groups (—COO—) in the system, no hydrogen bond is particularly formed between the ester groups (—COO—), and thus the groups do not function as a hydrogen-bonding cross-linking moiety. On the other hand, when a structure, having both a hydrogen acceptor portion and a hydrogen donor portion for hydrogen bond such as a carboxy group and a triazole ring, is contained in the side chains of the polymer molecules, hydrogen bonds are formed between the side chains of the polymer molecules, and thus a hydrogen-bonding cross-linking moiety is contained. In addition, for example, when an ester group and a hydroxyl group coexist between the side chains of the polymer molecules, and these groups contribute to the formation of a hydrogen bond between the side chains, the portion where the hydrogen bond is formed becomes the hydrogen-bonding cross-linking moiety. Therefore, it may be used as the side chain (c) depending on the structure itself of the side chain (b), the type of the structure of the side chain (b) and the substituents of the other side chains, and the like.). In addition, the “covalent-bonding cross-linking moiety” mentioned here is a portion that cross-links polymer molecules by covalent bonding.

The side chain (b) containing a covalent-bonding cross-linking moiety is not particularly limited, but is preferably, for example, a side chain containing a covalent-bonding cross-linking moiety which is formed by reacting a maleic anhydride graft-modified thermoplastic polymer; and a cross-linking agent made up of a compound capable of reacting with a maleic anhydride group (functional group) to form a covalent-bonding cross-linking moiety (hereinafter referred to as a “compound that forms a covalent-bonding cross-linking moiety (compound that forms a covalent bond)” in some cases). The cross-linking of the side chain (b) at the covalent-bonding cross-linking moiety is preferably formed by at least one bond selected from the group consisting of amides, esters, and thioesters.

The “compound that forms a covalent-bonding cross-linking moiety (compound that forms a covalent bond)” which can be used as a cross-linking agent is preferably a compound having a substituent that reacts with a maleic anhydride group (such as a hydroxyl group, a thiol group, an amino group, or an imino group), and more preferably a compound having at least one of a hydroxyl group, an amino group, and an imino group. In addition, it is particularly preferable that the compound having a substituent that reacts with such a maleic anhydride group (more preferably a compound having at least one of a hydroxyl group, an amino group, and an imino group) has a nitrogen-containing heterocycle.

In addition, examples of the “compound that forms a covalent-bonding cross-linking moiety (compound that forms a covalent bond)” which can be used as a cross-linking agent include a polyamine compound having two or more amino groups and/or imino groups in one molecule (in the case of having both amino groups and imino groups, a total of two or more of these groups); a polyol compound having two or more hydroxyl groups in one molecule; a polyisocyanate compound having two or more isocyanate (NCO) groups in one molecule; and a polythiol compound having two or more thiol groups (mercapto groups) in one molecule. Here, the “compound that forms a covalent-bonding cross-linking moiety (compound that forms a covalent bond)” can be a compound capable of introducing both the hydrogen-bonding cross-linking moiety and the covalent-bonding cross-linking moiety depending on the type of substituents of the compound, the degree of progress of the reaction when the reaction is carried out using the compound, and the like (for example, when a compound having three or more hydroxyl groups is used as a cross-linking agent to form a cross-linking moiety by a covalent bond, there may be a case where two hydroxyl groups react with the functional group (maleic anhydride group) of the maleic anhydride graft-modified thermoplastic polymer, and the remaining one hydroxyl group remains as a hydroxyl group depending on the degree of progress of the reaction, and in that case, a moiety that forms a hydrogen-bonding cross-link can also be introduced). Therefore, the “compound that forms a covalent-bonding cross-linking moiety (compound that forms a covalent bond)” exemplified here may also include a “compound that forms both a hydrogen-bonding cross-linking moiety and a covalent-bonding cross-linking moiety.” From this viewpoint, in the case of forming the side chain (b), the side chain (b) may be formed by appropriately selecting a compound from the “compound that forms a covalent-bonding cross-linking moiety (compound that forms a covalent bond)” according to the desired design, appropriately controlling the degree of reaction progress, and the like. Note that when the compound that forms a covalent-bonding cross-linking moiety has a heterocycle, it is possible to more efficiently produce a hydrogen-bonding cross-linking moiety at the same time, and efficiently form a side chain having the covalent-bonding cross-linking moiety as the side chain (c) described later. Therefore, a specific example of a compound having such a heterocycle is described as a suitable compound for producing the side chain (c), particularly together with the side chain (c). Note that it can be said the side chain (c) is a preferable form of the side chain such as the side chain (a) and the side chain (b) because of its structure.

As the polyamine compound, the polyol compound, the polyisocyanate compound, and the polythiol compound that can be used as the “compound that forms a covalent-bonding cross-linking moiety (compound that forms a covalent bond),” it is possible to appropriately use known ones (for example, those described in paragraphs [0094] to [0106] of JP 5918878 B).

<Side Chain (c): Side Chain Containing Both Hydrogen-Bonding Cross-Linking Moiety and Covalent-Bonding Cross-Linking Moiety>

The side chain (c) is a side chain containing both a hydrogen-bonding cross-linking moiety and a covalent-bonding cross-linking moiety in one side chain. The hydrogen-bonding cross-linking moiety contained in the side chain (c) is the same as the hydrogen-bonding cross-linking moiety described in the side chain (a′), and is preferably the same as the hydrogen-bonding cross-linking moiety in the side chain (a). In addition, as the covalent-bonding cross-linking moiety contained in the side chain (c), one same as the covalent-bonding cross-linking moiety in the side chain (b) can be used (this is the case for a suitable cross-linking thereof).

The side chain (c) is preferably a side chain formed when a maleic anhydride graft-modified thermoplastic polymer is reacted with a cross-linking agent composed of a compound that forms both a hydrogen-bonding cross-linking moiety and a covalent-bonding cross-linking moiety (compound that introduces both a hydrogen-bonding cross-linking moiety and a covalent-bonding cross-linking moiety) on reaction with a functional group (maleic anhydride group) of the maleic anhydride graft-modified thermoplastic polymer.

The “compound that forms both a hydrogen-bonding cross-linking moiety and a covalent-bonding cross-linking moiety (compound that introduces both a hydrogen-bonding cross-linking moiety and a covalent-bonding cross-linking moiety)” that can be used as a cross-linking agent is preferably a compound having a substituent that reacts with a maleic anhydride group (such as a hydroxyl group, a thiol group, an amino group, or an imino group), and more preferably a compound having at least one of a hydroxyl group, an amino group, an imino group, and a thiol group. In addition, the compound that forms both a hydrogen-bonding cross-linking moiety and a covalent-bonding cross-linking moiety (compound that introduces both a hydrogen-bonding cross-linking moiety and a covalent-bonding cross-linking moiety) is preferably a compound having a heterocycle (particularly preferably a nitrogen-containing heterocycle) and capable of forming a covalent-bonding cross-linking moiety (compound that forms a covalent bond), and among others, heterocyclic polyols, heterocyclic polyamines, heterocyclic polythiols, and the like are more preferable. Note that, as the polyol, polyamine, or polythiol containing a heterocycle, it is possible to appropriately use one same as the polyol compound, the polyamine compound, or the polythiol compound described in the above-mentioned “compound capable of forming a covalent-bonding cross-linking moiety (compound that forms a covalent bond)” except that a heterocycle (particularly a nitrogen-containing heterocycle) is contained. In addition, as polyols, polyamines, and polythiols containing a heterocycle, it is possible to appropriately use known ones (for example, ones described in paragraph [0113] of JP 5918878 B).

(Regarding Structure Suitable as Covalent-Bonding Cross-Linking Moiety in Side Chains (b) and (c))

Regarding the side chain (b) and/or (c), it is preferable that the cross-linking at the covalent-bonding cross-linking moiety contains a tertiary amino bond (—N═) and an ester bond (—COO—), and these bonding sites also function as hydrogen-bonding cross-linking moieties, from the viewpoint that the cross-linking is stronger by hydrogen bonding with other hydrogen bond cross-linking moieties. As described above, when a tertiary amino bond (—N═) or an ester bond (—COO—) in a side chain having a covalent-bonding cross-linking moiety forms a hydrogen bond with another side chain, the covalent-bonding cross-linking moiety containing the tertiary amino bond (—N═) and the ester bond (—COO—) also includes a hydrogen-bonding cross-linking moiety, and can function as a side chain (c).

Preferable examples of the compound capable of forming a covalent-bonding cross-linking moiety (compound capable of forming both a hydrogen-bonding cross-linking moiety and a covalent-bonding cross-linking moiety: a type of cross-linking agent) containing the tertiary amino bond and/or the ester bond by reacting with a maleic anhydride group as a functional group in the maleic anhydride graft-modified thermoplastic polymer can include polyethylene glycol laurylamine (for example,

N,N-bis(2-hydroxyethyl)laurylamine), polypropylene glycol laurylamine (for example, N,N-bis(2-methyl-2-hydroxyethyl)laurylamine), polyethylene glycol octylamine (for example, N,N-bis(2-hydroxyethyl)octylamine), polypropylene glycol octylamine (for example, N,N-bis(2-methyl-2-hydroxyethyl)octylamine), polyethylene glycol stearylamine (for example, N,N-bis(2-hydroxyethyl)stearylamine), and polypropylene glycol stearylamine (for example, N,N-bis(2-methyl-2-hydroxyethyl)stearylamine).

The cross-link of the side chain (b) and/or the side chain (c) at the covalent-bonding cross-linking moiety may be of the same structure described in paragraphs [0100] to [0109] of JP 2017-206604 A, for example. For instance, as the cross-link of the side chain (b) and/or the side chain (c) at the covalent-bonding cross-linking moiety, it is possible to appropriately use one containing at least one structure represented by any of the following general formulas (1) to (3) (note that, in the following structure, when a hydrogen-bonding cross-linking moiety is included, the side chain having that structure is used as the side chain (c)).

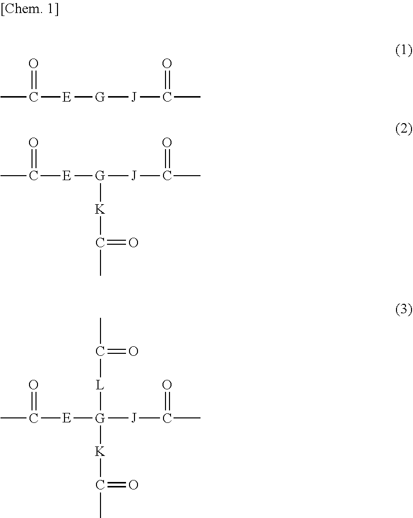

In the above general formulas (1) to (3), E, J, K, and L are each independently a single bond; an oxygen atom, an amino group NR'(R′ is a hydrogen atom or an alkyl group having 1 to 10 carbon atoms), or a sulfur atom; or an organic group which may contain these atoms or groups, and G may contain an oxygen atom, a sulfur atom, or a nitrogen atom, and is a linear, branched, or cyclic hydrocarbon group having 1 to 20 carbon atoms. In addition, the substituent G is preferably groups represented by the following general formulas (111) to (114).

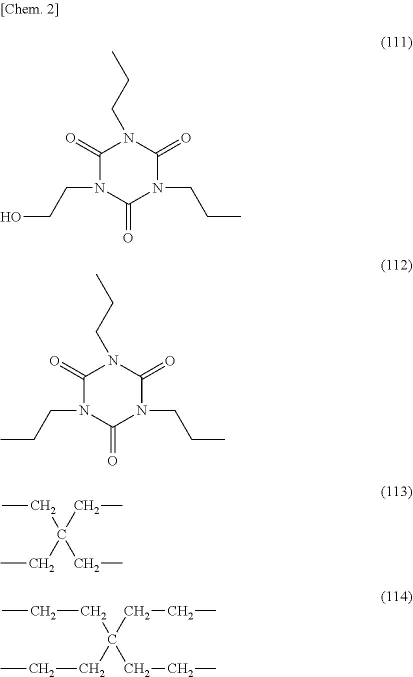

The side chain (a′), the side chain (a), the side chain (b), and the side chain (c) have been described above, and each group (structure) of the side chain in the polymer can be confirmed by a commonly used analytical means such as NMR and IR spectra.

In addition, the polymer (A) is a polymer having the side chain (a) and having a glass transition point of 25° C. or lower, and the polymer (B) is a polymer containing a hydrogen-bonding cross-linking moiety and a covalent-bonding cross-linking moiety in the side chain and having a glass transition point of 25° C. or lower (such as a polymer having both the side chain (a′) and the side chain (b) as side chains, or a polymer containing the side chain (c) in the side chain). Then, as the polymer ingredient according to the present invention, one of the polymers (A) and (B) may be used alone, or two or more of them may be mixed and used.

Note that the polymer (B) may be a polymer having both the side chain (a′) and the side chain (b), or a polymer having the side chain (c), and the hydrogen-bonding cross-linking moiety contained in the side chain of the polymer (B) is preferably a hydrogen-bonding cross-linking moiety having a carbonyl-containing group and/or a nitrogen-containing heterocycle (more preferably a hydrogen-bonding cross-linking moiety having a carbonyl-containing group and a nitrogen-containing heterocycle) from the viewpoint that a stronger hydrogen bond is formed. In addition, the cross-link at the covalent-bonding cross-linking moiety contained in the side chain of the polymer (B) is preferably formed by at least one bond selected from the group consisting of amides, esters, and thioesters from the viewpoint that it is possible to induce intermolecular interactions such as hydrogen bonds between the side chains including the cross-linking moiety.

Further, the polymers (A) and (B) according to the present invention are both a reaction product of a cross-linking agent with a maleic anhydride graft-modified thermoplastic polymer having a melting point of 64° C. or lower and a maleation rate of 0.1 to 3.0% by mass.

The maleic anhydride graft-modified thermoplastic polymer used for forming the polymers (A) and (B) as described above has a melting point of 64° C. or lower (more preferably 60° C. to −100° C., and further preferably 57° C. to −50° C.). When the melting point of the maleic anhydride graft-modified thermoplastic polymer exceeds the upper limit, the hardness of the polymer composition increases, making it impossible to sufficiently lower the hardness. The melting point employed is a value measured by differential scanning calorimetry (DSC). Note that, in the measurement of the melting point, the rate of temperature rise is set to 10° C./min to carry out measurement.

In addition, the maleic anhydride graft-modified thermoplastic polymer has a maleation rate of 0.1 to 3.0% by mass (more preferably 0.2 to 2.7% by mass, and further preferably 0.3 to 2.5% by mass). When the maleation rate is less than the lower limit, even if a cross-linking reaction is carried out, it is impossible to sufficiently increase the cross-linking density, resulting in a tendency to fail to sufficiently increase the mechanical properties of the polymer composition. Meanwhile, when the upper limit is exceeded, the fluidity tends to decrease.

Note that in the present invention, the value (unit: % by mass) of the “maleation rate” is a value obtained by employing the following [Method for Measuring Maleation Rate].

### [Method for Measuring Maleation Rate]

First, 400 mg of the maleic anhydride graft-modified thermoplastic polymer as the measurement target is dissolved in 80 mL of tetrahydrofuran (hereinafter sometimes abbreviated as “THF” for convenience) to obtain a THF solution for measurement. Next, the THF solution for measurement is titrated with an ethanol solution of 0.1 mol/L potassium hydroxide for which a factor having three or more decimal places has been obtained (standard solution for volumetric analysis: ethanol solution of 0.1 mol/L potassium hydroxide with correction: a commercially available one with a factor (characteristic value: corrected value) having three or more decimal places may be used). Here, the end point (neutralization point) is obtained by potentiometric titration using an instrument. In addition, the factor (characteristic value: corrected value) of the ethanol solution of 0.1 mol/L potassium hydroxide may be determined by titration with an oxalic acid standard solution, and in the case of using a commercially available product for which a factor has been obtained, the factor described on a commercially available reagent (for example, the factor described in the test report of that reagent) may be used as it is. Then, the same measurement is performed except for not using a maleic anhydride graft-modified thermoplastic polymer (blank test) to carry out titration and to also determine the amount (blank value) of an ethanol solution of 0.1 mol/L potassium hydroxide dropped to 80 mL of THF. Next, the acid value is calculated based on the following “Acid Value Calculation Formula” using the obtained titration value (amount dropped). Then, the obtained acid value is used to calculate the maleation rate based on the following “Maleation Rate Calculation Formula.” As a result, the maleation rate (unit: % by mass) is obtained.

### <Acid Value Calculation Formula>

[Acid Value]=(A−B)×M₁×C×f/S

(in the formula, A indicates the amount dropped of the ethanol solution of 0.1 mol/L potassium hydroxide required for neutralizing the solution for measurement (titration value: mL), B indicates the amount dropped of 0.1 mol/L potassium hydroxide in ethanol solution in a blank (blank test) (titration value (blank value: mL) obtained by performing the same measurement except for not using a maleic anhydride graft-modified thermoplastic polymer), M₁ indicates the molecular weight of potassium hydroxide (56.1 (constant)), C indicates the concentration of potassium hydroxide in the ethanol solution of potassium hydroxide (0.1 mol/L (constant)), f indicates the factor of the ethanol solution of potassium hydroxide (corrected value: the factor described on a commercially available reagent (for example, the factor described in the test report of a reagent) may be used as they are), S indicates the mass (400 g (constant)) of the maleic anhydride graft-modified thermoplastic polymer used for the measurement. Note that the unit of “acid value” obtained by the above calculation is “mg KOH/g.”)

### <Maleation Rate Calculation Formula>

[Maleation Rate]=[Acid Value]±M₁×M₂±1000×100±2

(in the formula, the acid value indicates the value (unit: mg KOH/g) obtained by the above “Acid Value Calculation Formula,” M₁ indicates the molecular weight of potassium hydroxide (56.1 (constant)), and M₂ indicates the molecular weight of maleic anhydride (98.1 (constant)). The unit of “maleation rate” obtained by the above calculation is “% by mass.”).

In addition, as the main chain of the maleic anhydride graft-modified thermoplastic polymer (polymer forming the main chain portion of the polymers (A) and (B)), it is possible to use those appropriately selected from so-called thermoplastic polymers so that the melting point of the maleic anhydride graft-modified thermoplastic polymer is 64° C. or lower (note that the “thermoplastic polymer” in the maleic anhydride graft-modified thermoplastic polymer mentioned in the present specification may be a polymer having thermoplasticity and having a melting point of 64° C. or lower (more preferably having a melting point in the range of 60° C. to −100° C.), and may be, for example, the so-called “elastomer” or “rubber”).

The main chain of the maleic anhydride graft-modified thermoplastic polymer (polymer forming the main chain portion of the polymers (A) and (B)) is not particularly limited, but among others, more preferably at least one selected from the group consisting of polyolefin-based polymers, polyester-based polymers, polyamide-based polymers, polystyrene-based polymers, polyacrylate-based polymers, polyacrylonitrile-based polymers, polyacetal-based polymers, polycarbonate-based polymers, and polyolefin-acrylate copolymers, further preferably a polyolefin-based polymer, a polyacrylate-based polymer, or a polyolefin-acrylate copolymer, and particularly preferably a polyolefin-based polymer.

The polyolefin-based polymer suitable as the main chain of the maleic anhydride graft-modified thermoplastic polymer is not particularly limited, and may be a polymer of an α-olefin, or may be a polymer composed of a copolymer of an α-olefin and another copolymerizable monomer. Among others, from the viewpoint that the hardness of the polymer composition can be more easily lowered, such polyolefin-based polymer is preferably polypropylene (PP), polyethylene (PE), an ethylene-butene copolymer (EBM), an ethylene-propylene copolymer (EPM), an ethylene-octene copolymer (EOM), or an ethylene-propylene-diene copolymer (EPDM), more preferably an ethylene-butene copolymer (EBM), an ethylene-propylene copolymer (EPM), an ethylene-octene copolymer (EOM), or an ethylene-propylene-diene copolymer (EPDM), and further preferably an ethylene-butene copolymer (EBM), an ethylene-octene copolymer (EOM), or an ethylene-propylene-diene copolymer (EPDM).

Note that the maleic anhydride graft-modified thermoplastic polymer is a graft-modified product (thermoplastic polymer graft-modified with maleic anhydride) obtained by graft-modifying the thermoplastic polymer described as the main chain with maleic anhydride. Therefore, the maleic anhydride graft-modified thermoplastic polymer is preferably a polyolefin-based polymer graft-modified with maleic anhydride, and more preferably a maleic anhydride graft-modified product of at least one polyolefin-based polymer selected from the group consisting of PP, PE, EBM, EPM, EOM, and EPDM. Note that the maleic anhydride graft-modified thermoplastic polymer may be used alone, or two or more of them may be mixed and used.

In addition, the maleic anhydride graft-modified thermoplastic polymer may be a graft-modified product (thermoplastic polymer graft-modified with maleic anhydride) obtained by graft-modifying the thermoplastic polymer with maleic anhydride and may satisfy the above-mentioned conditions for melting point and maleation rate, and the production method thereof is not particularly limited, and can be easily produced by employing a known method for preparing a maleic anhydride graft-modified thermoplastic polymer and appropriately adjusting the type of raw material and the amount used thereof so as to satisfy the above conditions. In addition, as such a maleic anhydride graft-modified thermoplastic polymer, a commercially available product may be appropriately used as long as it satisfies the above conditions.

In addition, the cross-linking agent is not particularly limited and may be any as long as it can react with the maleic anhydride group in the maleic anhydride graft-modified thermoplastic polymer to form any of the polymers (A) and (B), and depending on the desired design, one may appropriately select and use a compound capable of reacting with a maleic anhydride group to form various cross-linked moieties (compound capable of forming a target side chain).

As such a cross-linking agent, it is possible to appropriately use the above-mentioned “compound that forms a hydrogen-bonding cross-linking moiety (more preferably a compound capable of introducing a nitrogen-containing heterocycle)” or “compound that forms a covalent-bonding cross-linking moiety (compound that forms a covalent bond).” In addition, as such a cross-linking agent, a compound having at least one of a hydroxyl group, an amino group, an imino group, and a thiol group is preferable from the viewpoint that the reaction proceeds efficiently. In addition, the compound having at least one of a hydroxyl group, an amino group, an imino group, and a thiol group is more preferably a compound having a nitrogen-containing heterocycle (the nitrogen-containing heterocycle is more preferably at least one selected from a triazole ring, an isocyanurate ring, a thiadiazole ring, a pyridine ring, an imidazole ring, a triazine ring, and a hydantoin ring) (note that the “nitrogen-containing heterocycle” mentioned here is the same as that described above, including those suitable for use). Examples of the compound having at least one of a hydroxyl group, an amino group, an imino group, and a thiol group include tris(2-hydroxyethyl)isocyanurate, 2,4-diamino-6-phenyl-1,3,5 -triazine (benzoguanamine), 2,4-diamino-6-methyl-1,3,5-triazine (acetoguanamine), 3-amino-1,2,4-triazole, aminopyridine (2-, 3-, 4-), 3-amino-5-methylisoxazole, 2-aminomethylpiperidine, 1 -(2-hydroxyethyl)imidazole, 2-butyl-5-hydroxymethylimi dazole, 1,3-dihydro-l-phenyl-2H-benzimidazole-2-thione, chelidamic acid, kojic acid, 2,5-dimercapto-1,3,4-thiadiazole, 1-phenyl-5-mercapto-1,2,3,4-tetrazole, 1-methyl-5-mercapto-1,2,3,4-tetrazole, tris hydroxyethyl triazine, tris-[(3-mercaptopropionyloxy)-ethyl]isocyanurate, hydroxypyridine (2-, 3-, 4-), 1-hydroxybenzotriazole, 1-(2-aminoethyl)piperazine, bis(aminopropyl)piperazine, piperidine ethanol (2-, 3-, 4-), piperidine methanol (2-, 3-, 4-), pyridine ethanol (2-, 3-, 4-), pyridine methanol (2-, 3-, 4-), benzoguanamine, 4-methyl-5-(2′-hydroxyethyl)thiazole, 1-methylol-5, 5-dimethylhydantoin, melamine, and mercaptopyridine (2-, 3-, 4-). Such compounds may be used alone or in admixture of two or more.

In addition, from the viewpoint of high reactivity and industrial availability, the cross-linking agent is preferably at least one compound selected from the group consisting of nitrogen-containing compounds which may have at least one substituent from a hydroxyl group, a thiol group, an amino group, and an imino group, oxygen-containing compounds which may have at least one substituent from a hydroxyl group, a thiol group, an amino group, and an imino group, and sulfur-containing compounds which may have at least one substituent from a hydroxyl group, a thiol group, an amino group, and an imino group. Note that the “compound that forms a hydrogen-bonding cross-linking moiety (compound that can introduce a nitrogen-containing heterocycle)” and “compound that forms a covalent-bonding cross-linking moiety (compound that forms a covalent bond)” can be appropriately selected from known compounds (compounds described in Japanese Unexamined Patent Application Publication No. 2017-57322 and JP 5918878 B) and used as long as they can react with a maleic anhydride group.

In addition, the cross-linking agent is preferably at least one selected from the group consisting of triazoles which may have at least one substituent from a hydroxyl group, a thiol group, an amino group, and an imino group; pyridines which may have at least one substituent from a hydroxyl group, a thiol group, an amino group, and an imino group; thiadiazoles which may have at least one substituent from a hydroxyl group, a thiol group, an amino group, and an imino group; imidazoles which may have at least one substituent from a hydroxyl group, a thiol group, an amino group, and an imino group; isocyanurates which may have at least one substituent from a hydroxyl group, a thiol group, an amino group, and an imino group; triazines which may have at least one substituent from a hydroxyl group, a thiol group, an amino group, and an imino group; hydantoins which may have at least one substituent from a hydroxyl group, a thiol group, an amino group, and an imino group; tris(2-hydroxyethyl)isocyanurate; 2,4-diamino-6-phenyl-1,3,5-triazine; pentaerythritol; sulfamide; and polyether polyols.

From the viewpoint of resistance against compression set, the cross-linking agent is preferably tris(2-hydroxyethyl)isocyanurate, sulfamide, pentaerythritol, 2,4-diamino-6-phenyl-1,3,5-triazine, 2,4-diamino-6-methyl-1,3,5-triazine, and polyether polyol, and further preferably pentaerythritol, 2,4-diamino-6-phenyl-1,3,5-triazine, 2,4-diamino-6-methyl-1,3,5-triazine, and tris(2-hydroxyethyl)isocyanurate.

In addition, the method for obtaining a reaction product of the maleic anhydride graft-modified thermoplastic polymer and the cross-linking agent is not particularly limited, and may be a method capable of forming the polymers (A) and (B) by reacting a maleic anhydride group in the maleic anhydride graft-modified thermoplastic polymer with a functional group in a cross-linking agent (may be a method capable of forming the cross-linking moiety described in the polymers (A) and (B)), and the reaction may be appropriately carried out according to the type of the cross-linking agent and the like. For example, one may employ a method in which a cross-linking agent is added and reacted while mixing (kneading) the maleic anhydride graft-modified thermoplastic polymer using a kneading machine such as a kneader at a temperature at which the maleic anhydride graft-modified thermoplastic polymer can be plasticized and the cross-linking agent to be added can be reacted with the maleic anhydride group (for example, about 100 to 250° C.).

Further, the polymer composition of the present invention containing such a polymer ingredient has a type A durometer hardness (JIS-A hardness) of 0 to 49 (more preferably 0 to 45, and further preferably 0 to 40) measured under a temperature condition of 20±5° C. according to JIS K6253-3: 2012. If the type A durometer hardness (JIS-A hardness) exceeds the upper limit, the hardness cannot be a sufficiently low value, and the composition becomes too hard, making it impossible to obtain higher flexibility. Note that such a type A durometer hardness (JIS-A hardness) can be easily achieved if the polymer composition contains the above-mentioned specific polymer ingredients (if the polymer ingredients may be mixed with an additional ingredient depending on the type of polymer ingredient, in some cases). Further, in the present invention, as the method for measuring the value of type A durometer hardness (JIS-A hardness), a measuring method based on JIS K6253-3 issued in 2012 (JIS K6253-3: 2012) may be employed with the temperature condition set to 20±5° C., and for example, the following measurement methods can be employed. The value can be obtained as follows. Specifically, first, a pressure press machine with a water cooling function is used to heat to 200° C. Then, 43 g of the polymer composition is placed in a mold having a length of 15 cm, a width of 15 cm, and a thickness of 2 mm, and heated (preheated) at 200° C. for 3 minutes before pressurization, and then pressurized (heat pressed) under the conditions of temperature: 200° C., working pressure: 20 MPa, and pressurization time: 5 minutes, and then further subjected to a water-cooled press under the conditions of working pressure: 20 MPa and pressurizing time: 2 minutes, and the polymer composition after pressing is taken out of the mold to prepare measurement sheets having a thickness of 2 mm. Then, the sheets are punched into a disk shape having a diameter of 29 mm. Seven of the obtained disk-shaped sheets are stacked to a height (thickness) of 12.5±0.5 mm to prepare a measurement sample. A method (A) is employed in which the obtained measurement sample is used and a type A durometer (durometer A hardness tester) is used to measure the hardness of each of the five points on the surface of the measurement sample in accordance with JIS K6253-3 (issued in 2012) under a temperature condition of 20±5° C., and the hardness is obtained as the average value thereof.

Further, from the viewpoint of having sufficient flexibility, the polymer composition of the present invention preferably has a type E durometer hardness (JIS-E hardness) of 73 or less, more preferably 70 or less, and particularly preferably 67 or less, which is measured under a temperature condition of 20±5° C. according to JIS K6253-3: 2012. As the method for measuring the value of the type E durometer hardness (JIS-E hardness), a measuring method based on JIS K6253-3 issued in 2012 (JIS K6253-3: 2012) may be employed with the temperature condition set to 20±5° C. For example, the measurement can be performed by employing the same method as the above-mentioned method (A) except that a type E type durometer (durometer E hardness tester) is used instead of the type A type durometer.

Further, depending on the application, for example, from the viewpoint of making a polymer composition having an ultra-low hardness, the polymer composition of the present invention is preferably such that the type A durometer hardness (JIS-A hardness) is 0 and the type E durometer hardness (JIS-E hardness) is 15 or less (more preferably 10 or less, and further preferably 5 or less).

In addition, the polymer composition of the present invention may contain ingredients other than the polymer ingredients from the viewpoint of appropriately adjusting the hardness and other characteristics according to the intended use. When such an additional ingredient is contained, from the viewpoint of setting the type A durometer hardness (JIS-A hardness) to 0 to 49 and sufficiently lowering the compression set value, the content of the polymer ingredients in the polymer composition of the present invention is preferably 3% by mass or more, more preferably 4% by mass to 99% by mass, further preferably 4% by mass to 90% by mass, and particularly preferably 4% by mass to 80% by mass. When the content of the polymer ingredients in such a polymer composition is less than the above lower limit, the effect obtained based on the polymer ingredients tends to be low. Meanwhile, when the upper limit is exceeded, mixing tends to be difficult.

In addition, the polymer composition of the present invention preferably contains a reinforcing agent (filler) as the additional ingredient from the viewpoint of improving the breaking physical properties (breaking strength, elongation at break). The reinforcing agent is not particularly limited, and a known reinforcing agent (which may be a hydrogen-bonding reinforcing agent (filler) or a filler having an amino group introduced therein (hereinafter simply referred to as “amino group-introduced filler” in some cases)) can be appropriately used. As the reinforcing agent, for example, silica, carbon black, clay (which may be organic clay), calcium carbonate (which may be surface-treated), and the like are preferable.

In addition, as the reinforcing agent, clay is more preferable from the viewpoint that the tensile physical properties can be further improved and the bleed resistance can be further improved. As the clay, it is possible to appropriately use known clay (for example, that described in paragraphs [0146] to of JP 5918878 B, that described in paragraphs [0146] to [0155] of Japanese Unexamined Patent Application Publication No. 2017-057393, and the like). In addition, among such clays, from the viewpoint of high dispersibility, at least one selected from the group consisting of clays containing silicon and magnesium as main ingredients and organic clays is preferable, and organic clays are particularly preferable. As described above, the polymer composition of the present invention preferably further contains clay, and particularly preferably contains organic clay.

In addition, when the polymer composition of the present invention contains the reinforcing agent (preferably clay, and further preferably organic clay), the content of the reinforcing agent is preferably 20 parts by mass or less, and more preferably 0.01 to 10 parts by mass relative to 100 parts by mass of the polymer ingredient. As the reinforcing agent, one kind may be used alone, or two or more kinds may be used in combination depending on the intended use.

Moreover, the polymer composition of the present invention preferably contains a plasticizer as the additional ingredient from the viewpoint that the fluidity of the composition can be further improved and the workability during use becomes higher, and further, the hardness of the polymer composition can be adjusted more efficiently. The plasticizer is not particularly limited, and known ones can be appropriately used. Examples thereof include process oils, polybutene having no chemically bondable cross-linking moiety (more preferably a copolymer mainly composed of isobutylene (isobutene) and partially reacted with normal butene), polyisobutylene having no chemically bondable cross-linking moiety (isobutylene (isobutene) homopolymer), and the like. In addition, in this specification, “having no chemically bondable cross-linking moiety” means that it does not include a site where a cross-link is formed by a chemical bond such as hydrogen bond, covalent bond, chelation between metal ion and polar functional group, and bond formed by the σ-π interaction between metal and unsaturated bond (double and triple bonds).

Examples of the process oils that can be used as a plasticizer include paraffinic oil, naphthenic oil, and aroma oil, and among these, paraffinic oil is more preferable. Further, from the viewpoint of further improving compatibility with styrene block copolymers, α-olefin-based polymers, polymers (A), and polymers (B) (among these, especially with styrene block copolymers), the plasticizer more preferably contains paraffinic oil, and more preferably contains polybutene having no chemically bondable cross-linking moiety and/or polyisobutylene having no chemically bondable cross-linking moiety from the viewpoint that the polymer composition has less stickiness and bleed and it is possible to more efficiently achieve an ultra-low hardness such that the JIS-A hardness is 0 and the JIS-E hardness is 15 or less. As above, from the viewpoint of obtaining characteristics (such as hardness) according to the intended use, the polymer composition of the present invention preferably further contains at least one plasticizer selected from the group consisting of process oils, polybutenes having no chemically bondable cross-linking moiety, and polyisobutylenes having no chemically bondable cross-linking moiety. The content of the plasticizer is preferably 10 to 5000 parts by mass, particularly preferably 30 to 3000 parts by mass, based on 100 parts by mass of the polymer ingredient.

The paraffinic oil suitable as a plasticizer is not particularly limited, and known paraffinic oils can be appropriately used. For example, it is possible to preferably use ones described in paragraphs [0153] to [0157] of Japanese Unexamined Patent Application Publication No. 2017-57323. Note that the paraffinic oil is preferably such that, when correlation ring analysis (n-d-M ring analysis) based on ASTM D3238-85 is performed on the oil to determine the percentage of the number of paraffinic carbons to the total number of carbons (paraffinic part: CP), the percentage of the number of naphthenic carbons to the total number of carbons (naphthenic part: CN), and the percentage of the number of aromatic carbons to the total number of carbons (aromatic part: CA), the percentage of the number of the paraffinic carbons (CP) to the total number of carbons is 60% or more. In addition, from the viewpoint of fluidity and safety, the paraffinic oil preferably has a kinematic viscosity of 10 mm²/s to 700 mm²/s at 40° C., which is measured in accordance with JIS K 2283 (issued in 2000). Moreover, from the viewpoint of fluidity and safety, the paraffinic oil has an aniline point of preferably 80° C. to 150° C. measured by the U-shaped tube method based on JIS K2256 (issued in 2013). As the method for measuring the kinematic viscosity and the aniline point, it is possible to employ the methods described in paragraphs [0153] to [0157] of JP 2017-57323 A. As such paraffinic oil, commercially available ones can be appropriately used.

When the paraffinic oil is contained in the polymer composition, the content of the paraffinic oil is preferably 10 to 5000 parts by mass, and particularly preferably 30 to 3000 parts by mass relative to 100 parts by mass of the polymer ingredient. When the content of the paraffinic oil is less than the lower limit, the content of paraffinic oil is too low, and the effects obtained by adding paraffinic oil, such as improving fluidity and workability, tend to be insufficient. Meanwhile, when the upper limit is exceeded, bleeding of paraffinic oil is likely to be induced, and it tends to be difficult to obtain a polymer composition in a uniform state.

Further, the polybutene that can be used as a plasticizer is not particularly limited as long as it has no chemically bondable cross-linking moiety, but is more preferably a copolymer mainly composed of isobutylene (isobutene) and partially reacted with normal butene (1-butene, 2-butene), from the viewpoint that it is possible to reduce the hardness while reducing stickiness and bleed, and it is possible to further improve the fluidity. In addition, as the polybutene as a plasticizer, a commercially available product can be appropriately used. For example, the trade name “Nisseki Polybutene” manufactured by JXTG Nippon Oil & Energy Corporation, the trade name “NOF Polybutene Emawet” manufactured by NOF Corporation, the trade name “Oppanol” manufactured by BASF, and the like can be appropriately used.

Further, when the polybutene is contained in the polymer composition, the content of polybutene is preferably 10 to 5000 parts by mass, particularly preferably 30 to 3000 parts by mass, based on 100 parts by mass of the polymer ingredient. When the content of the polybutene is less than the above lower limit, the content of the polybutene is too small, and it tends to be difficult to sufficiently obtain the effects obtained by containing polybutene (reduction of hardness and improvement of fluidity). Meanwhile, when the upper limit is exceeded, the content of polybutene becomes too large and bleeding tends to occur, and the strength tends to decrease.

Further, the polyisobutylene that can be used as a plasticizer is not particularly limited as long as it has no chemically bondable cross-linking moiety. A homopolymer of isobutylene (isobutene) is more preferable from the viewpoint that the hardness can be further lowered and the fluidity can be further improved. In addition, as the polyisobutylene as a plasticizer, commercially available products can be appropriately used, and for example, trade names “Tetrax” and “Himol” manufactured by JXTG Nippon Oil & Energy Corporation can be appropriately used.

Further, when the polyisobutylene is contained in the polymer composition, the content thereof is preferably 10 to 5000 parts by mass, particularly preferably 30 to 3000 parts by mass, based on 100 parts by mass of the polymer ingredient. When the content of the polyisobutylene is less than the above lower limit, the content of the polyisobutylene is too small, and it tends to be difficult to sufficiently obtain the effects obtained by containing polyisobutylene (reduction of hardness and improvement of fluidity). Meanwhile, when the upper limit is exceeded, the content of polyisobutylene becomes too large and bleeding tends to occur, and the strength tends to decrease.

Further, from the viewpoint of preventing bleeding when the plasticizer is used (particularly when oil is used) and the like, the polymer composition of the present invention preferably contains, as the additional ingredient, a styrene block copolymer having no chemically bondable cross-linking moiety. Therefore, the polymer composition of the present invention preferably contains the plasticizer (more preferably at least one selected from the group consisting of the paraffinic oil, the polybutene, and the polyisobutylene) in combination with the styrene block copolymer having no chemically bondable cross-linking moiety.

Further, the polymer composition of the present invention preferably contains the paraffinic oil as the plasticizer in combination with the styrene block copolymer. This makes it possible for the styrene block copolymer to absorb oil, improve the fluidity of the obtained polymer composition to a higher degree while suppressing oil bleeding and the like more sufficiently, and adjust the hardness more efficiently. As the styrene block copolymer having no chemically bondable cross-linking moiety, it is possible to preferably use ones described in paragraphs [0156] to [0163] of Japanese Unexamined Patent Application Publication No. 2017-57393. Note that the “styrene block copolymer” may be any polymer having a styrene block structure at any site.

Further, in the polymer composition of the present invention, it is preferable to contain polybutene and/or polyisobutylene as the plasticizer in combination with a styrene block copolymer. This makes it easier to allow the polymer composition to have an ultra-low hardness such that the JIS-A hardness is 0 and the JIS-E hardness is 15 or less, and moreover to suppress surface bleeding to a higher degree when used in combination with a styrene block copolymer.

The styrene block copolymer having no chemically bonding cross-linking moiety is preferably a styrene block copolymer having a styrene content of 10 to 50% by mass (more preferably 20 to 40% by mass) from the viewpoint of mechanical strength and oil absorption. In addition, from the viewpoint of mechanical strength and oil absorption, as the weight average molecular weight (Mw), number average molecular weight (Mn), and dispersity of the molecular weight distribution (Mw/Mn) of the styrene block copolymer, Mw is preferably 200,000 or more and 700,000 or less (more preferably 350,000 or more and 550,000 or less), Mn is preferably 100,000 or more and 600,000 or less (more preferably 200,000 or more and 500,000 or less), and the Mw/Mn is preferably 5 or less (more preferably 1 to 3). From the viewpoint of elastomeric properties (from the viewpoint of having sufficient elastomeric properties), the glass transition point of the styrene block copolymer is preferably -80 to -30° C. (more preferably −70 to −40° C.). As a method for measuring such various characteristics (such as Mw and Mn), the methods described in paragraphs [0156] to [0163] of JP 2017-57393 A are employed.

As the styrene block copolymer having no chemically bonding cross-linking moiety, it is possible to appropriately use known ones (such as SIS, SEPS, SBS, SIBS, SEEPS, and SEBS), and styrene-ethylene-ethylene-propylene-styrene block copolymer (SEEPS) and styrene-ethylene-butylene-styrene block copolymer (SEBS) are more preferable from the viewpoint of high molecular weight, industrial availability, and economy. As the styrene block copolymer, one kind may be used alone, or two or more kinds may be used in combination. As the styrene block copolymer, a commercially available one can be appropriately used. Note that SEBS and SEEPS are more preferable from the viewpoint of further improving oil bleeding resistance when used in combination with the plasticizer (particularly paraffinic oil, polybutene, polyisobutylene). Further, from the viewpoint of obtaining an ultra-low hardness polymer composition having the JIS-A hardness of 0 and the JIS-E hardness of 15 or less, the polymer composition of the present invention particularly preferably contains the polymer ingredient, the polybutene and/or the polyisobutylene, and the SEEPS.

In addition, when the polymer composition of the present invention contains the styrene block copolymer having no chemically bonding cross-linking moiety, the content of the styrene block copolymer is preferably 1 to 3000 parts by mass, and more preferably 5 to 2000 parts by mass relative to 100 parts by mass of the polymer ingredient. Further, when used in combination with the paraffinic oil, the content of the styrene block copolymer is more preferably 1 to 3000 parts by mass, further preferably 5 to 2000 parts by mass. When the content ratio is less than the lower limit, the oil tends to bleed easily when the oil is added. Meanwhile, when the upper limit is exceeded, the moldability tends to decrease. Further, when used in combination with the polybutene and/or the polyisobutylene, the content of the styrene block copolymer is more preferably 1 to 3000 parts by mass, further preferably 5 to 2000 parts by mass. When the content ratio is less than the lower limit, it tends to be difficult to sufficiently obtain the effects obtained by containing the styrene block copolymer (effect of sufficiently suppressing oil bleeding). Meanwhile, when the upper limit is exceeded, the content of the styrene block copolymer becomes too large, and the moldability tends to decrease.

Further, the polymer composition of the present invention may further contain, as the additional component, an α-olefin-based polymer having no chemically bondable cross-linking moiety. The “α-olefin-based polymer” mentioned here refers to a homopolymer of α-olefin and a copolymer of α-olefin, and the “α-olefin” refers to an alkene having a carbon-carbon double bond at the a-position, and examples thereof include ethylene, propylene, 1-butene, 1-pentene, 1-hexene, 1-heptene, 1-octene, 1-nonene, 1-decene, and the like. However, in the present invention, the polybutene and the polyisobutylene are used as plasticizers, so that the term “α-olefin-based polymer” mentioned here refers to ones other than the polybutene and the polyisobutylene. As the α-olefin polymer having no chemically bondable cross-linking moiety, it is possible to preferably use the α-olefin-based resins (but excluding polybutene and polyisobutylene) described in paragraphs [0204] to [0214] of JP 2017-57322 A, for example.

In addition, as the α-olefin-based polymer having no chemically bondable cross-linking moiety, it is possible to preferably use polypropylene, polyethylene (PE, more preferably HDPE), ethylene-propylene copolymer, ethylene-butene copolymer (EBM), and ethylene-octene copolymer, for example. In addition, among the above α-olefin-based polymers, it is possible to preferably use an α-olefin-based polymer having a crystallinity of 10% or more (such as polypropylene, ethylene-propylene copolymer, ethylene-butene copolymer, or polyethylene). The method for producing an α-olefin-based polymer having no chemically bonding cross-linking moiety is not particularly limited, and a known method can be appropriately employed. In addition, as such an α-olefin-based polymer, a commercially available product may be used. Note that, as the α-olefin-based polymer having no chemically bonding cross-linking moiety, one kind may be used alone, or two or more kinds may be used in combination.

When an α-olefin-based polymer having no chemically bonding cross-linking moiety is contained in the polymer composition, the content of the α-olefin-based polymer is more preferably 500 parts by mass or less (more preferably 5 to 300 parts by mass, and most preferably 35 to 200 parts by mass) relative to 100 parts by mass of the polymer ingredient. When the content of such an α-olefin-based polymer is less than the lower limit, the effect tends to be low. Meanwhile, when the upper limit is exceeded, the hardness tends to be so high that it becomes difficult to impart a sufficiently high degree of flexibility to the polymer composition.

Note that from the viewpoint that higher fluidity and higher moldability can be obtained, the α-olefin-based polymer having no chemically bondable cross-linking moiety is preferably contained in the composition in combination with the paraffinic oil and the styrene block copolymer.

In addition, the polymer composition of the present invention preferably contains an anti-aging agent and/or an antioxidant, depending on its use. The anti-aging agent and the antioxidant are not particularly limited, and known ones can be appropriately used. Note that the content of the anti-aging agent and antioxidant is not particularly limited, but is preferably 20 parts by mass or less (more preferably 0.01 to 10 parts by mass) relative to 100 parts by mass of the polymer ingredient.

Further, in the polymer composition of the present invention, depending on the intended use and design, in addition to the above-mentioned additional ingredients (such as the reinforcing agent (filler), the plasticizer (softening agent), the styrene block copolymer and the α-olefin-based polymer, the anti-aging agent, and the antioxidant), known additives used in compositions containing polymers (such as those described in paragraphs [0169] to [0174] of JP 5918878 B) may be further used as additional ingredients. The additive that can be further used (additional ingredient) is not particularly limited, it is possible to appropriately use a known ingredient that can be used in the field of compositions including polymers, and examples thereof include various ingredients such as polymers other than the polymer ingredients (A) and (B), amino group-containing compounds other than the amino group-introduced fillers, compounds containing metal elements, pigments (dyes), thixotropy-imparting agents, ultraviolet absorbers, flame retardants, solvents, surfactants (including leveling agents), various oils other than the process oils, dispersants, dehydrators, corrosion inhibitors, adhesives, antistatic agents, fillers, lubricants, and processing aids (vulcanization accelerators such as stearic acid and zinc oxide when vulcanizing). In addition, as the additional ingredients, one kind may be used alone, or two or more kinds may be used in combination depending on the intended use.

In addition, the method for producing the polymer composition is not particularly limited, and any method can be used as long as the reaction product of the maleic anhydride graft-modified thermoplastic polymer with the cross-linking agent can be contained in the composition. Such method may be, for example, the method described in paragraphs [0181] to [0215] of Japanese Unexamined Patent Application Publication No. 2016-193970 with an alteration that the “raw material compound” described in the publication is changed to the “cross-linking agent.” Except for that, the same method as the method described in the same paragraphs of the publication may be employed to react the maleic anhydride graft-modified thermoplastic polymer with the cross-linking agent, thereby producing a polymer composition containing the polymer ingredient made up of the obtained reaction product.

In addition, for example, as a method for producing the polymer composition, it is possible to preferably employ a method for obtaining a polymer composition containing the polymer ingredient by mixing the maleic anhydride graft-modified thermoplastic polymer, the cross-linking agent, and the additional ingredient as necessary (such as the reinforcing agent, the styrene block copolymer having no chemically bonding cross-linking moiety, the plasticizer (such as paraffinic oil and polybutene), the α-olefin-based polymer having no chemically bonding cross-linking moiety, the anti-aging agent, the antioxidant, or the additive). In this method, during the mixing, it is preferable to prepare the polymer (A) and the polymer (B) by reacting a maleic anhydride group in the maleic anhydride graft-modified thermoplastic polymer with a functional group in the cross-linking agent to form a specific cross-link. In addition, in this method, during the mixing, the maleic anhydride graft-modified thermoplastic polymer can be reacted with the cross-linking agent, and during the reaction, the maleic anhydride group contained in the maleic anhydride graft-modified thermoplastic polymer can be opened to form a chemical bond with the cross-linking agent. Thereby, “at least one polymer ingredient selected from the group consisting of the polymer (A) and the polymer (B)” as the target can be efficiently formed according to the type of the ingredient.

In addition, when the maleic anhydride graft-modified thermoplastic polymer is reacted with the cross-linking agent by the above method, the amount of the cross-linking agent used is preferably 0.1 to 10 parts by mass, and more preferably 0.2 to 5.0 parts by mass relative to 100 parts by mass of the maleic anhydride graft-modified thermoplastic polymer. When the amount of the cross-linking agent added (amount based on parts by mass) is less than the lower limit, the amount of the cross-linking agent is too small, the cross-linking density does not increase, and the desired physical properties tend not to be exhibited. Meanwhile, when the upper limit is exceeded, the amount is too large and there are many branches (the proportion of the cross-linking agent not involved in the cross-linking is increased because the amount of the cross-linking agent is too large), and the cross-linking density tends to decrease.

In addition, in the above method, the temperature condition when the maleic anhydride graft-modified thermoplastic polymer is reacted with the cross-linking agent (maleic anhydride group is opened) is not particularly limited, and may be adjusted to a temperature at which they can react, depending on the type of the cross-linking agent and the like. For example, the temperature is preferably 100 to 250° C., and more preferably 120 to 230° C. from the viewpoint of softening and instantly advancing the reaction. In addition, the mixing method for carrying out the reaction is not particularly limited, and it is possible to appropriately employ a known method of mixing with a roll, a kneader, or the like. Moreover, when additional ingredients are added, the order of addition of the ingredients is not particularly limited, and may be appropriately changed according to the type of the ingredient to be used. For example, in the production of the polymer composition, in the case of adding the styrene block copolymer having no chemically bonding cross-linking moiety, the paraffinic oil, and the α-olefin-based polymer having no chemically bonding cross-linking moiety as additional ingredients, the following method may be employed. For example, a method may be employed in which the styrene block copolymer and the paraffinic oil are first mixed under temperature conditions of 100 to 250° C. to obtain a mixture, then the maleic anhydride graft-modified thermoplastic polymer and the α-olefin-based polymer are added to the mixture under the temperature conditions followed by mixing and plasticization, and a cross-linking agent is added thereto and mixed under the temperature conditions to react the maleic anhydride graft-modified thermoplastic polymer with the cross-linking agent, thereby obtaining a polymer composition containing a reaction product of the maleic anhydride graft-modified thermoplastic polymer and the cross-linking agent, the styrene block copolymer, the paraffinic oil, and the α-olefin-based polymer. Note that, when additional ingredients such as the reinforcing agent (filler) and the anti-aging agent are further contained, the ingredients may be appropriately added and mixed at any stage according to the ingredients to be used, and the order of addition of these ingredients is also not particularly limited, but when a reinforcing agent is added, from the viewpoint of further improving its dispersibility, it is preferable to mix the reinforcing agent with the maleic anhydride graft-modified thermoplastic polymer before adding and mixing the cross-linking agent. Note that the amount and the like of these additional ingredients added can be appropriately changed according to the desired design (for example, the amount added may be appropriately set so as to be within the above-mentioned suitable content range).

The polymer composition of the present invention is useful as a material and the like for producing a polymer product used for applications such as daily necessities, automobile parts, electric appliances, and industrial parts, and among others, particularly preferable for use in machinery, electrical equipment housings and protective devices, interior members of houses and automobiles, skin of humanoid robots (androids and humanoids), toys, and the like, which require soft tactile sensation mainly by human touch, because the hardness can be sufficiently reduced.

### EXAMPLES

Hereinafter, the present invention is described in more detail based on Examples and Comparative Examples, but the present invention is not limited to the following Examples.

### [Regarding Maleic Anhydride-Modified Thermoplastic Polymer Used in Each Example]

Table 1 presents abbreviation, polymer types, characteristics, and the like of the maleic anhydride-modified thermoplastic polymer used in each Example. In addition, the “maleation rate” presented in Table 1 is a value obtained by employing [Method for Measuring Maleation Rate] described above (note that in the titration, the automatic potentiometric titrator used was the trade name “AT-710M” manufactured by Kyoto Electronics Manufacturing Co., Ltd., and the ethanol solution of 0.1 mol/L potassium hydroxide used was the trade name “Potassium Hydroxide Solution in Ethanol” manufactured by Merck & Co., Inc. The corrected value (factor) of the ethanol solution of 0.1 mol/L potassium hydroxide used in this manner was 1.00 as confirmed from the test report of the solution.). In addition, the “melting point” presented in Table 1 is a value measured by using 0.01 g of each polymer and using a differential scanning calorimeter (manufactured by Hitachi High-Tech Corporation under the trade name “DSC7000X”) at a rate of temperature rise of 10° C/min (value obtained by differential scanning calorimetry (DSC)).

TABLE 1

| | | | | | Melting Point |
|---|---|---|---|---|---|
| | | | | Maleation | [Softening |
| | Type of | Trade Name | | Rate | Point] |
| Abbreviation | Modification | (Manufacturer) | Polymer Type | (Mass %) | (° C.) |
| TP(1) | Graft Modified | Fusabond N493 | Maleated EOM | 0.50 | 50 |
| | | (DuPont de Nemours, Inc.) | | | |
| TP(2) | Graft Modified | Fusabond N525 | Maleated EBM | 0.90 | 51 |
| | | (DuPont de Nemours, Inc.) | | | |
| TP(3) | Graft Modified | AMPLIFY GR 216 | Maleated EOM | 0.80 | 63 |
| | | (The Dow Chemical Company) | | | |
| TP(4) | Graft Modified | Fusabond N416 | Maleated EPDM | 0.90 | 43 |
| | | (DuPont de Nemours, Inc.) | | | |
| TP(5) | Graft Modified | Tafmer MP0620 | Maleated EPM | 0.80 | 57 |
| | | (Mitsui Chemicals, Inc.) | | | |
| TP(6) | Graft Modified | Tafmer MH7020 | Maleated EBM | 0.80 | 57 |
| | | (Mitsui Chemicals, Inc.) | | | |
| TP(7) | Graft Modified | Fusabond P353 | Maleated PP | 1.60 | 136 |
| [Comparative | | (DuPont de Nemours, Inc.) | (Copolymerized) | | |
| Ingredient] | | | | | |
| TP(8) | Graft Modified | Fusabond P613 | Maleated PP | 0.53 | 162 |
| [Comparative | | (DuPont de Nemours, Inc.) | (Homo) | | |
| Ingredient] | | | | | |
| TP(9) | Copolymerized | Lotader 3410 | Maleated E-BA17% | 3.10 | 47 |
| [Comparative | | (Arkema) | | | |
| Ingredient] | | | | | |
| TP(10) | Copolymerized | Lotader 4210 | Maleated E-BA6.5% | 3.60 | 69 |
| [Comparative | | (Arkema) | | | |
| Ingredient] | | | | | |
| TP(11) | Copolymerized | Lotader TX8030 | Maleated E-EA13% | 2.80 | 65 |
| [Comparative | | (Arkema) | | | |
| Ingredient] | | | | | |

### [Method for Evaluating Characteristics of Polymer Composition Obtained in Each Example]

### <Preparation of Measurement Sheet>

The polymer composition obtained in each of the Examples and the like was used to prepare a sheet for use in evaluating the characteristics of the composition as follows. Specifically, first, a pressure press machine with a water cooling function was used to heat to 200° C. Then, 43 g of the polymer composition was placed in a mold having a length of 15 cm, a width of 15 cm, and a thickness of 2 mm, and heated (preheated) at 200° C. for 3 minutes before pressurization, and then pressurized (heat pressed) under the conditions of temperature: 200° C., working pressure: 20 MPa, and pressurization time: 5 minutes, and then further subjected to a water-cooled press under the conditions of working pressure: 20 MPa and pressurizing time: 2 minutes, and the polymer composition after pressing was taken out of the mold to obtain measurement sheets having a thickness of 2 mm.

### <Preparation of Sample (Measurement Sample) for Measuring Compression Set and Hardness>

The measurement sheets obtained as described above were each used to prepare a measurement sample for use in measuring the compression set and hardness of the composition as follows. Specifically, first, seven disk-shaped sheets, punched out of the measurement sheets into a disk shape having a diameter of 29 mm, were prepared, and then the seven disk-shaped sheets were stacked to a height (thickness) of 12.5±0.5 mm to prepare a measurement sample.

### <Measurement of Compression Set (C-Set)>

The compression set (C-Set) of the polymer composition obtained in each of the Examples and the like was obtained by using the measurement sample obtained as described above, using the trade name “Vulcanized Rubber Compression Set Test Machine SCM-1008L” manufactured by DUMBBELL CO., LTD. as a compression device to compress the measurement sample by 25% with a special jig, and measuring the compression set (unit: %) after leaving it at 70° C. for 22 hours in accordance with JIS K6262 (issued in 2013).

### <Measurement of Hardness (JIS-A Hardness and E Hardness)>

The hardness of the polymer composition obtained in each of the Examples and the like was measured as follows using the measurement sample obtained as described above. Specifically, a type A durometer (durometer A hardness tester: trade name “Type A Durometer GSD-719K” manufactured by Teclock) was used for the measurement of JIS -A hardness, and meanwhile a type E durometer (durometer E hardness tester: trade name “Type E Durometer GSD-721K” manufactured by Teclock) was used for the measurement of JIS-E hardness, and hardness measurement was performed on 5 measurement locations (5 measurement points) on the surface of the measurement sample under the temperature condition of 20±5° C., according to JIS K6253-3 (issued in 2012), and the average value of the hardnesses at those measurement points (the average value for the 5 points) was calculated to obtain the A hardness and the E hardness.

### <Stickiness Evaluation Method>

The stickiness of the polymer composition obtained in each of the Examples and the like was evaluated as follows. Specifically, first, five testers gave a score of 1 to 5 for the surface of each measuring sheet having a thickness of 2 mm obtained as described above by finger touch based on the following evaluation criteria. Those with an average value of 3.0 points or higher were evaluated as stickiness “yes,” and those with an average value of less than 3.0 points were evaluated as stickiness “none”.

### <Evaluation Criteria (Stickiness)>

1 point: No stickiness is felt
2 points: Almost no stickiness is felt
3 points: A little stickiness is felt
4 points: Stickiness is felt
5 points: Stickiness is strongly felt.

### Examples 1 to 6 and Comparative Examples 1 to 5

In each of the Examples 1 to 6 and Comparative Examples 1 to 5, the polymer composition was produced by adjusting the amount of each ingredient used so as to have the compositions presented in Tables 2 to 3 below and employing the “Step of Producing Polymer Composition” described later. Note that the numerical values of the compositions in Tables 2 to 3 below are values (parts by mass) obtained by the conversion where the amount of the maleic anhydride-modified thermoplastic polymer (TP(1) to (11)) used in Examples and the like is set to 100 parts by mass, and in Examples 1 to 6 and Comparative Examples 1 to 5, the amount of the maleic anhydride graft-modified thermoplastic polymer used was 10 g. The evaluation results for the characteristics (C-Set, hardness, stickiness) of the polymer compositions thus obtained are shown in Tables 2 and 3.

### <Step of Producing Polymer Composition>

First, the styrene block copolymer (styrene-ethylene-butylene-styrene block copolymer, manufactured by Kraton under the trade name “G1651HU,” styrene content 33% by mass: hereinafter sometimes referred to as “SEBS”) was charged into a pressure kneader, and while mixing under the condition of 180° C., paraffinic oil as a plasticizer (manufactured by JXTG Nippon Oil & Energy Corporation under the trade name “300HV-S(J)”) was added dropwise to the pressure kneader, and SEBS and paraffinic oil were mixed for 1 minute. Next, into the pressure kneader, a maleic anhydride-modified thermoplastic polymer, an ethylene-butene copolymer (manufactured by Mitsui Chemicals, Inc. under the trade name “TAFMER DF7350”: hereinafter sometimes referred to as “EBM”), a high density polyethylene (manufactured by Japan Polyethylene Corporation under the trade name “HJ590N”: hereinafter sometimes referred to as “HDPE”), and an anti-aging agent (manufactured by ADEKA Corporation under the trade name “AO-50”) were further added, and mixed (kneaded) at 180° C. for 2 minutes and plasticized to obtain a mixture (A). Then, a polymer composition was produced by performing either of the following steps (I) and (II):
[Step (I)] a step of adding a cross-linking agent (cross-linking agent (1) or (2)) as it is to the mixture (A) to mix (knead) at 180° C. for 8 minutes; and
[Step (II)] a step of adding clay (manufactured by Hojun Co., Ltd. under the trade name “ESBEN WX”: organic clay) to the mixture (A) to mix (kneading) at 180° C. for 4 minutes and then adding a cross-linking agent (cross-linking agent (1) or (2)) to mix (knead) at 180° C. for 8 minutes.

Note that in Examples 1 to 2 and 4 to 5 and Comparative Examples 1 and 4, the mixture (A) was obtained, and then the step (I) was performed, and in Examples 3 and 6 and Comparative Examples 2 to 3 and 5, the mixture (A) was obtained and then the step (II) was performed. Further, regarding the cross-linking agent, the “cross-linking agent (1)” used was tris(2-hydroxyethyl)isocyanurate (manufactured by Nissei Corporation under the trade name “TANAC P”), and the “cross-linking agent (2)” used was benzoguanamine (trade name “Benzoguanamine” manufactured by Nippon Shokubai Co., Ltd.).

### <Regarding Tables 2 and 3>

(1) In Tables 2 to 3, the types of maleic anhydride-modified thermoplastic polymers used in the Examples and the like are presented using the abbreviations shown in Table 1 for convenience.
(2) In Tables 2 to 3, in “Evaluation of Maleation Rate” for the maleic anhydride-modified thermoplastic polymer, those satisfying the condition that the maleation rate is in the range of 0.1 to 3.0% by mass are referred to as “S,” whereas those not satisfying the condition that the maleation rate is in the range of 0.1 to 3.0% by mass are referred to as “F.”
(3) In Tables 2 to 3, in “Evaluation of Melting Point” for the maleic anhydride graft-modified thermoplastic polymer, those having a melting point satisfying the condition of 64° C. or lower are referred to as “S,” whereas those having a melting point satisfying the condition of 64° C. or lower (having a melting point higher than 64° C.) are referred to as “F.”

TABLE 2

| | | | Example 1 | Example 2 | Example 3 | Example 4 | Example 5 | Example 6 |
|---|---|---|---|---|---|---|---|---|
| Maleic Anhydride-Modified | | Abbreviation | TP(1) | TP(2) | TP(3) | TP(4) | TP(5) | TP(6) |
| Thermoplastic Polymer | | Type of | Graft | Graft | Graft | Graft | Graft | Graft |
| | | Modification | | | | | | |
| | | Evaluation of | S | S | S | S | S | S |
| | | Maleation Rate | | | | | | |
| | | Evaluation of | S | S | S | S | S | S |
| | | Melting Point | | | | | | |
| Composition | Maleic Anhydride-Modified | | 100 | 100 | 100 | 100 | 100 | 100 |
| (Mass Parts) | Thermoplastic Polymer | | | | | | | |
| | Cross-Linking | Cross-Linking | 0.49 | 0.88 | 0.78 | — | — | — |
| | Agent | Agent (1) | | | | | | |
| | | Cross-Linking | — | — | — | 0.95 | 0.84 | 0.84 |
| | | Agent (2) | | | | | | |
| | Clay | | — | — | 0.1 | — | — | 0.1 |
| | Anti-Aging Agent | | 2.01 | 2.01 | 2.01 | 2.01 | 2.01 | 2.01 |
| | Styrene Block Copolymer (SEBS) | | 100.0 | 100.0 | 100.0 | 100.0 | 100.0 | 100.0 |
| | Plasticizer (Paraffinic Oil) | | 333.3 | 333.3 | 333.3 | 333.3 | 333.3 | 333.3 |
| | α-Olefin-Based | HDPE | 66.7 | 66.7 | 66.7 | 66.7 | 66.7 | 66.7 |
| | Polymer | EBM | 66.7 | 66.7 | 66.7 | 66.7 | 66.7 | 66.7 |

| | | | | | | |
|---|---|---|---|---|---|---|
| JIS-A Hardness | 49 | 40 | 49 | 34 | 37 | 38 |
| JIS-E Hardness | 72 | 67 | 73 | 61 | 62 | 63 |
| Compression Set (70° C., 22H, 25%) | 42 | 35 | 41 | 41 | 27 | 31 |
| Stickiness | None | None | None | None | None | None |

TABLE 3

| | | | Comparative | Comparative | Comparative | Comparative | Comparative |
|---|---|---|---|---|---|---|---|
| | | | Example 1 | Example 2 | Example 3 | Example 4 | Example 5 |
| Maleic Anhydride-Modified | | Abbreviation | TP(7) | TP(8) | TP(9) | TP(10) | TP(11) |
| Thermoplastic Polymer | | Type of | Graft | Graft | Copolymerized | Copolymerized | Copolymerized |
| | | Modification | | | | | |
| | | Evaluation of | S | S | F | F | S |
| | | Maleation Rate | | | | | |
| | | Evaluation of | F | F | S | F | F |
| | | Melting Point | | | | | |
| Composition | Maleic Anhydride-Modified | | 100 | 100 | 100 | 100 | 100 |
| (Mass Parts) | Thermoplastic Polymer | | | | | | |
| | Cross-Linking | Cross-Linking | 1.56 | — | 3.03 | 3.52 | — |
| | Agent | Agent (1) | | | | | |
| | | Cross-Linking | — | 0.56 | — | — | 2.63 |
| | | Agent (2) | | | | | |
| | Clay | | — | 0.1 | 0.1 | — | 0.1 |
| | Anti-Aging Agent | | 2.01 | 2.01 | 2.02 | 2.02 | 2.02 |
| | Styrene Block Copolymer (SEBS) | | 100.0 | 100.0 | 100.0 | 100.0 | 100.0 |
| | Plasticizer (Paraffinic Oil) | | 333.3 | 333.3 | 333.3 | 333.3 | 333.3 |
| | α-Olefin-Based | HDPE | 66.7 | 66.7 | 66.7 | 66.7 | 66.7 |
| | Polymer | EBM | 66.7 | 66.7 | 66.7 | 66.7 | 66.7 |

| | | | | | |
|---|---|---|---|---|---|
| JIS-A Hardness | 66 | 69 | 40 | 45 | 40 |
| JIS-E Hardness | 83 | 86 | 66 | 71 | 66 |
| Compression Set (70° C., 22H, 25%) | 58 | 61 | 50 | 46 | 52 |
| Stickiness | None | None | Yes | Yes | Yes |

### Examples 7 and 8

Polymer compositions were produced by employing the same steps as the “Step of Producing Polymer Composition” employed in Examples 1 to 6 and Comparative Examples 1 to 5 described above except that ethylene-butene copolymer (EBM) and high density polyethylene (HDPE) were not used, a styrene-ethylene-ethylene-propylene-styrene block copolymer (SEEPS) was used as the styrene block copolymer instead of SEBS, polybutene was used as a plasticizer instead of paraffinic oil, and the amount of each component used was adjusted so that the composition (part by mass) had the composition shown in Table 4. Here, in both Examples 7 and 8, tris(2-hydroxyethyl)isocyanurate (cross-linking agent (1)) was used as the cross-linking agent. Further, in Example 7 and Example 8, different types of commercially available products were used as SEEPS (In Example 7, the trade name “SEPTON 4099” manufactured by Kuraray Co., Ltd. was used as SEEPS, and in Example 8, the trade name “HYBRAR 7135R” manufactured by Kuraray Co., Ltd. was used as SEEPS.). In addition, in Examples 7 and 8, the trade name “Nisseki Polybutene LV-7” manufactured by JXTG Nippon Oil & Energy Corporation was used as the polybutene. Further, in Example 7, step (I) was performed and no clay was added, and in Example 8, step (II) was performed and clay was added. Table 4 shows the evaluation results for the characteristics (C-Set, hardness, stickiness) of the polymer compositions thus obtained. The contents of the items “Evaluation of Maleation Rate” and “Evaluation of Melting Point” are the same as those in Tables 2 and 3.

TABLE 4

| | | Example | Example |
|---|---|---|---|
| | | 7 | 8 |
| Maleic Anhydride- | Abbreviation | TP(4) | TP(4) |
| Modified | Type of Modification | Graft | Graft |
| Thermoplastic | Evaluation of Maleation | S | S |
| Polymer | Rate | | |
| | Evaluation of Melting | S | S |
| | Point | | |

| | | | |
|---|---|---|---|
| Composition | Maleic Anhydride-Modified | 100 | 100 |
| (Mass Parts) | Thermoplastic Polymer | | |
| | Cross-Linking Agent (Cross- | 0.88 | 0.88 |
| | Linking Agent (1) was used) | | |
| | Clay | — | 0.10 |
| | SEEPS*¹ | 300 | 300 |
| | Polybutene (Plasticizer) | 1500 | 2000 |
| | Anti-Aging Agent | 570 | 7.20 |

| | | |
|---|---|---|
| JIS-A Hardness | 0 | 0 |
| JIS-E Hardness | 1.0 | 3.0 |
| Compression Set (70° C., 22H, 25%) | 41 | 41 |
| Stickiness | None | None |

*¹in the table indicates that the types of SEEPS are different between Examples 7 and 8, Example 7 used the trade name “SEPTON 4099” manufactured by Kuraray Co., Ltd. as SEEPS, and Example 8 used the trade name “HYBRAR 7135R” manufactured by Kuraray Co., Ltd. as SEEPS.

As is apparent from the descriptions in Tables 1 to 4, in any of the polymer compositions (Examples 1 to 8) containing a reaction product of a cross-linking agent with a maleic anhydride graft-modified thermoplastic polymer having a melting point of 64° C. or lower and a maleation rate of 0.1 to 3.0% by mass, the compression set (C-Set) was in the range of 42% or less, and the JIS-A hardness was 49 or less. Moreover, the polymer compositions obtained in Examples 1 to 8 were all non-sticky. As above, in any of the polymer compositions (Examples 1 to 8) obtained in Examples 1 to 8, it was found that a sufficiently low hardness could be achieved so that the JIS-A hardness was 49 or less, and the resistance to compression set was sufficiently good so that the value of compression set (C-Set) was 43% or less.

Meanwhile, among the condition that the melting point is 64° C. or lower (hereinafter referred to as “condition (I)”) and the condition that the maleation rate is 0.1 to 3.0% by mass (hereinafter referred to as “condition (II)”), in the case of polymer compositions (Comparative Examples 1 and 2) containing a reaction product of a cross-linking agent with a maleic anhydride graft-modified thermoplastic polymer not satisfying the above condition (I), the JIS-A hardness was 66 or more, failing to achieve a sufficiently low hardness such that the JIS-A hardness was 49 or less. Further, in the case of polymer compositions (Comparative Examples 1 and 2) containing a reaction product of a cross-linking agent with a maleic anhydride graft-modified thermoplastic polymer not satisfying the above condition (I), the compression set (C-Set) was 58% or more, failing to achieve a sufficiently low value of compression set (C-Set).

In addition, from the results shown in Table 3, when examining the cases where a thermoplastic polymer modified with maleic anhydride by copolymerization (hereinafter referred to as “copolymerization type maleic anhydride-modified thermoplastic polymer” in some cases) is used as a maleic anhydride-modified thermoplastic polymer (Comparative Examples 3 to 5), in any of the polymer compositions (Comparative Examples 3 to 5) containing a reaction product of a cross-linking agent with the copolymerization type maleic anhydride-modified thermoplastic polymer, stickiness occurred, failing to obtain a non-sticky polymer composition. Further, in the polymer composition (Comparative Example 3) obtained by using a copolymerization type maleic anhydride-modified thermoplastic polymer having a melting point of 64° C. or lower and a maleation rate of 3.1% by mass (maleic anhydride-modified thermoplastic polymer satisfying only the condition (I)), a sufficiently low hardness could be achieved, with a JIS-A hardness of 40, but the compression set value could not be sufficiently lowered, with a compression set (C-Set) of 50%, failing to achieve sufficiently low values of both hardness and compression set. Moreover, in the polymer composition (Comparative Example 4) obtained by using a copolymerization type maleic anhydride copolymer thermoplastic polymer having a melting point of 69° C. and a maleation rate of 3.6% by mass (maleic anhydride-modified thermoplastic polymer not satisfying either of the conditions (I) and (II)), a sufficiently low hardness could be achieved, with a JIS-A hardness of 45, but the value of compression set (C-Set) could not be sufficiently lowered, with a compression set of 46%. What is more, in the polymer composition (Comparative Example 4) obtained by using a copolymerization type maleic anhydride copolymer thermoplastic polymer having a melting point of 65° C. and a maleation rate of 2.8% by mass (maleic anhydride-modified thermoplastic polymer satisfying only the condition (II)), a sufficiently low hardness could be achieved, with a JIS-A hardness of 40, but the compression set value could not be sufficiently lowered, with a compression set (C-Set) of 52%, failing to achieve sufficiently low values of both hardness and compression set. As described above, in the polymer compositions obtained in Comparative Examples 1 to 5, it was impossible to achieve both a sufficiently low hardness and a sufficiently good resistance to compression set, nor to obtain a non-sticky composition.

Note that from the results shown in Table 4, in the polymer compositions (Examples 7 and 8) containing a combination of polybutene (plasticizer) and SEEPS in addition to a reaction product of a cross-linking agent with a maleic anhydride graft-modified thermoplastic polymer having a melting point of 64° C. or lower and a maleation rate of 0.1 to 3.0% by mass, the polymer compositions had an ultra-low hardness such that the JIS-A hardness was 0 and also the JIS-E hardness was 5 or less. Further, from the results shown in Table 4 and the results shown in Table 2, comparing the polymer compositions using paraffinic oil (Examples 1 to 6) with the polymer compositions using polybutene (Examples 7 to 8), it is found that both are non-sticky, but the use of polybutene as a plasticizer makes it possible to obtain a composition having a lower hardness.

### INDUSTRIAL APPLICABILITY

As described above, the present invention makes it possible to provide a polymer composition capable of being non-sticky and sufficiently lowering both the hardness value and the compression set value. Therefore, the polymer compositions of the present invention are particularly useful in applications that require a soft tactile sensation, primarily to the touch of humans, such as machinery, electrical equipment housings and protective devices, interior members of houses and automobiles, skin of humanoid robots (androids and humanoids), and toys.

1. A polymer composition comprising:
at least one polymer ingredient selected from the group consisting of a polymer (A) having a side chain (a) containing a hydrogen-bonding cross-linking moiety with a carbonyl-containing group and/or a nitrogen-containing heterocycle and having a glass transition point of 25° C. or lower, and a polymer (B) containing a hydrogen-bonding cross-linking moiety and a covalent-bonding cross-linking moiety in a side chain and having a glass transition point of 25° C. or lower, wherein
both the polymer (A) and the polymer (B) are a reaction product of a cross-linking agent with a maleic anhydride graft-modified thermoplastic polymer having a melting point of 64° C. or lower and a maleation rate of 0.1 to 3.0% by mass, and
a type A durometer hardness measured under a temperature condition of 20±5° C. according to JIS K6253-3: 2012 is 0 to 49.

2. The polymer composition according to claim 1, wherein the cross-linking agent is a compound having at least one of a hydroxyl group, an amino group, an imino group, and a thiol group.

3. The polymer composition according to claim 1, wherein the maleic anhydride graft-modified thermoplastic polymer is a polyolefin-based polymer graft-modified with maleic anhydride.

4. The polymer composition according to claim 3, wherein the polyolefin-based polymer graft-modified with maleic anhydride is a maleic anhydride graft-modified product of at least one polyolefin-based polymer selected from the group consisting of polypropylene, polyethylene, ethylene-butene copolymers, ethylene-propylene copolymers, ethylene-octene copolymers, and ethylene-propylene-diene copolymers.

5. The polymer composition according to claim 1, further comprising clay.

6. The polymer composition according to claim 1, further comprising a styrene block copolymer having no chemically bondable cross-linking moiety.

7. The polymer composition according to claim 1, further comprising at least one plasticizer selected from the group consisting of process oils, polybutenes having no chemically bondable cross-linking moiety, and polyisobutylenes having no chemically bondable cross-linking moiety.
